(19) United States
(12) Patent Application Publication
(10) Pub. No.: US 2013/0022831 A1
(43) Pub. Date: Jan. 24, 2013

(54) SOFT DILUTE COPPER ALLOY WIRE, SOFT DILUTE COPPER ALLOY PLATE AND SOFT DILUTE COPPER ALLOY STRANDED WIRE

(71) Applicants: Hideyuki Sagawa, Tokai-mura (JP); Seigi Aoyama, Kitaibaraki (JP); Hiromitsu Kuroda, Hitachi (JP); Toru Sumi, Hitachi (JP); Keisuke Fujito, Mito (JP)

(72) Inventors: Hideyuki Sagawa, Tokai-mura (JP); Seigi Aoyama, Kitaibaraki (JP); Hiromitsu Kuroda, Hitachi (JP); Toru Sumi, Hitachi (JP); Keisuke Fujito, Mito (JP)

(73) Assignee: Hitachi Cable, Ltd., Tokyo (JP)

(21) Appl. No.: 13/553,762

(22) Filed: Jul. 19, 2012

(30) Foreign Application Priority Data
Jul. 21, 2011 (JP) 2011-160356

(51) Int. Cl. B32B 5/02

(52) U.S. Cl. 428/606

(57) ABSTRACT

A soft dilute copper alloy wire is composed of a soft dilute copper alloy material containing an additive element selected from the group consisting of Ti, Mg, Zr, Nb, Cu, V, Ni, Mn, and Cr, and balance comprising Cu. An average size of crystal grains lying from a surface of the soft dilute copper alloy wire at least to a depth of 20% of a wire diameter is not greater than 20 μm.

The present application is based on Japanese patent application No. 2011-160356 filed on Jul. 21, 2011, the entire contents of which are incorporated herein by reference.

### BACKGROUND OF THE INVENTION

1. Field of the Invention

This invention relates to a novel soft dilute copper alloy wire, soft dilute copper alloy plate and soft dilute copper alloy stranded wire, which have a high electrical conductivity, and which have a high tensile strength and a high elongation rate even in a soft material, and which are small in hardness.

2. Description of the Related Art

In science and technology in recent years, electricity is used in every part as electric power for power sources, electric signals, etc., and cables and lead wires are used for conveying them, and also in the field of electronic components, conducting wires such as bonding wires are used. And, as materials for the conducting wires, relatively high electrical conductivity metals such as copper, silver, and gold, are used, and the copper wires among the others are often used in view of cost and the like.

The copper is broadly classified into hard copper and soft copper according to its molecular arrangement, etc. The copper of a type having desired properties is used according to a purpose of use.

For example, for cables for use in electronic equipment such as medical equipment, industrial robots, and notebook PCs, the cables are used under an environment in which an external force resulting from a combination of severe bending, torsion, tension, etc. is repeatedly loaded thereon. Thus, the rigid hard copper wire is unsuitable, so that the soft copper wire is used for such a cable. In addition, for some products of the bonding wires, the copper with small Vickers hardness (herein referred to as “hardness”) is preferred in order to lessen damage to aluminum pads of chips.

The conducting wires used for such applications are required to have such incompatible properties as excellent electrical conductivity (high electrical conductivity) and high tensile strength and elongation rate and small hardness, and the copper material having a small hardness while maintaining a high electrical conductivity and high tensile strength and elongation rate has been being developed to date.

JP-A-2002-363668 discloses a flex resistant cable conductor having excellent tensile strength, elongation rate and electrical conductivity, and particularly discloses a flex resistant cable conductor comprising a copper alloy wire rod formed by containing a 0.05 to 0.70 mass % concentration of indium having purity of not less than 99.99 mass % and a 0.0001 to 0.003 mass % concentration of phosphorus having purity of not less than 99.9 mass % in oxygen-free copper having purity of not less than 99.99 mass %.

JP-A-9-256084 discloses a flex resistant copper alloy wire containing 0.1 to 1.0 mass % of indium, 0.01 to 0.1 mass % of boron, and the balance of copper.

JP-A-61-224443 discloses a semiconductor device bonding with an elongation rate, tensile strength and conductor material hardness suitable for the semiconductor device bonding, by containing not more than 10 ppm of total amount of inevitable impurities including not more than 2 ppm of inevitable sulfur and silver impurities, in high purity copper having purity of not less than 99.999 mass %.

### SUMMARY OF THE INVENTION

However, JP-A-2002-363668 only relates to the hard copper wire, but has not studied a soft copper wire having an excellent tensile strength, elongation rate and small hardness. In addition, JP-A-2002-363668 has not shown Ti, Mg, Zr, Nb, Ca, V, Ni, Mn and Cr as kinds of additive elements. Further, since the contents of the additive element S and Ag are high, the electrical conductivity would be lowered.

Also, JP-A-9-256084 relates to the soft copper wire. Similarly to JP-A-2002-363668, JP-A-9-256084 has not shown Ti, Mg, Zr, Nb, Ca, V, Ni, Mn and Cr as kinds of additive elements. Further, since the contents of the additive element In and B are high, the electrical conductivity would be lowered. In addition, JP-A-9-256084 has not studied a soft copper wire having an excellent small hardness in association with tensile strength and elongation.

On the other hand, it is conceivable to ensure a high electrical conductivity by selecting a high electrical conductivity copper material, such as an oxygen-free copper (OFC), as the copper a material.

If this oxygen-free copper (OFC) is used as the raw material with no other elements being added in order to maintain its electrical conductivity, it may be effective to consider to increase the processing degree of copper wire rod drawing to make the internal crystalline texture of the oxygen-free copper fine and thereby make its high tensile strength and elongation compatible with each other. For this case, there is a problem that this method cannot be applied to soft wire rods, though it is suitable for the use as hard wire rods because of being hardened by the wire drawing.

In addition, JP-A-61-224443 describes lowering the hardness of the conductor material. JP-A-61-224/143 however failed to provide the copper conductor after drawing and annealing of the conductor material with a high elongation property and tensile strength while being small in hardness and maintaining its softness property. Thus, there is still a room for enhancement.

Accordingly, it is an object of the invention to provide a soft dilute copper alloy wire, soft dilute copper alloy plate and soft dilute copper alloy stranded wire, which have a high electrical conductivity, and which have a high tensile strength and a high elongation even in a soft material, and which are small in hardness.

(1) According to a first embodiment of the invention, a soft dilute copper alloy wire comprises:

a soft dilute copper alloy material containing an additive element selected from a group consisting of Ti, Mg, Zr, Nb, Ca, V, Ni, Mn, and Cr, and balance comprising Cu,

wherein an average size of crystal grains lying from a surface of the soft dilute copper alloy wire at least to a depth of 20% of a wire diameter is not greater than 20 μm.

In the first embodiment, the following modifications and changes can be made.

(i) The soft dilute copper alloy wire further contains:

higher than 2 massppm of oxygen; and

2 massppm to 12 massppm of sulfur.

(ii) A tensile strength is not less than 210 MPa;

an elongation rate is not less than 15%; and

a Vickers hardness is not more than 65 Hv.

(iii) An electrical conductivity is not lower than 98% IACS (International Annealed Copper Standard).

(iv) The soft dilute copper alloy wire further contains:

4 massppm to 55 massppm of Ti as the additive element; and

higher than 2 massppm and not more than 30 massppm of oxygen.

(2) According to a second embodiment of the invention, a soft dilute copper alloy plate comprises

a soft dilute copper alloy material containing an additive element selected from a group consisting of Ti, Mg, Zr, Nb, Ca, V, Ni, Mn, and Cr, and balance comprising Cu,

wherein an average size of crystal grains lying from a surface of the soft dilute copper alloy plate at least to a depth of 20% of a plate thickness is not greater than 20 μm.

In the second embodiment, the following modifications and changes can be made.

(i) The soft dilute copper alloy plate further contains:

higher than 2 massppm of oxygen; and

2 massppm to 12 massppm of sulfur.

(ii) A tensile strength is not less than 210 MPa;

an elongation rate is not less than 15%; and

a Vickers hardness is not more than 65 Hv.

(iii) An electrical conductivity is not lower than 98% IACS (International Annealed Copper Standard).

(iv) The soft dilute copper alloy plate contains:

4 massppm to 55 massppm of Ti as the additive element;

2 massppm to 12 massppm of sulfur; and

higher than 2 massppm and not more than 30 massppm of oxygen.

(3) According to a third embodiment of the invention, a soft dilute copper alloy stranded wire comprises

a plurality of the soft dilute copper alloy wires according to the first embodiment stranded together.

(Points of the Invention)

According to the invention, the soft dilute copper alloy material containing the particular additive element such as Ti and the balance comprising Cu has a crystalline texture that the average size of the crystal grains lying from the surface to the depth of 20% of the wire diameter or the plate thickness is not greater than 20 μm. Therefore, it is possible to provide the soft dilute copper alloy wire, the soft dilute copper alloy plate, and the soft dilute copper alloy stranded wire, which have a high tensile strength and elongation rate by making the crystal grains of its surface layer fine, and further which is compatible with softness (small hardness), and it is possible to provide them to provide a wide variety of product fields.

### BRIEF DESCRIPTION OF THE DRAWINGS

The preferred embodiments according to the invention will be explained below referring to the drawings, wherein:

FIG. 1 is a diagram for explaining a method of measuring an average crystal grain size in a surface layer of a sample;

FIG. 2 is a diagram showing a relationship between different annealing temperatures and elongation of example material 1 and comparative material 1;

FIG. 3 is a diagram showing a cross-sectional photograph in a radial direction of example material 1 at an annealing temperature of 500° C.;

FIG. 4 is a diagram showing a cross-sectional photograph in a radial direction of example material 1 at an annealing temperature of 700° C.;

FIG. 5 is a diagram showing a cross-sectional photograph in a radial direction of comparative material 1 at an annealing temperature of 500° C.;

FIG. 6 is a diagram showing a relationship between elongation and tensile strength of example material 2 and comparative material 2;

FIG. 7 is a diagram showing a relationship between elongation and hardness of example material 2 and comparative material 2;

FIG. 8 is a diagram showing a relationship between tensile strength and hardness of example material 2 and comparative material 2;

FIG. 9 is a diagram showing a cross-sectional photograph in a width direction of a comparative material 2 having a diameter of 0.05 mm;

FIG. 10 is a diagram showing a cross-sectional photograph in a width direction of an example material 2 having a diameter of 0.05 mm;

FIG. 11 is a schematic diagram showing a method of measuring an average crystal grain size in a surface layer;

FIG. 12 is a diagram showing a cross-sectional photograph in a width direction of an example material 3 having a diameter of 0.26 mm;

FIG. 13 is a diagram showing a cross-sectional photograph in a width direction of a comparative material 3 having a diameter of 0.26 mm;

FIG. 14 is a diagram showing a cross-sectional photograph in a width direction of an example material 4 having a diameter of 0.26 mm; and

FIG. 15 is a diagram showing a cross-sectional photograph in a width direction of a comparative material 4 having a diameter of 0.26 mm.

### DETAILED DESCRIPTION OF THE PREFERRED EMBODIMENTS

An embodiment of the invention will be described below, but the embodiment described below is not intended to limit the invention according to the appended claims. It should also be noted that not all combinations of features described in the following embodiments are essential to means for solving the problems of the invention.

(Constituents of the Soft Dilute Copper Alloy Material)

(1) Additive Elements

The soft dilute copper alloy material according to the invention contains an additive element selected from a group consisting of Ti, Mg, Zr, Nb, Ca, V, Ni, Mn, and Cr, and balance comprising Cu and an inevitable impurity.

As the additive element, the elements selected from the group consisting of Ti, Mg, Zr, Nb, Ca, V, Ni, Mn and Cr are active elements which tend to combine with other elements, and in particular tend to combine with S. Those additive elements can therefore trap S, and allow the copper matrix to have a high purity, and one kind or two or more kinds of those additive elements may be contained. Also, another element and inevitable impurity which do not adversely affect the properties of the alloy may be contained in the alloy.

In addition, the oxygen content is preferably higher than 2 massppm and not more than 30 massppm, and the oxygen content may, depending on the added element amount and the S content, be higher than 2 massppm and be 400 massppm, in the range of having the properties of the alloy.

(2) Composition Ratio

As the additive element, the total content of one kind or two or more kinds of Ti, Ca, V, Ni, Mn and Cr is preferably 4 to 55 massppm, more preferably 10 to 20 massppm, the content of Mg is preferably 2 to 30 massppm, more preferably 5 to 10 massppm, and the content of Zr and Nb is preferably 8 to 100 massppm, more preferably 20 to 40 massppm.

In addition, the oxygen content is preferably higher than 2 massppm and is 30 massppm or less, more preferably 5 to 15 massppm, and the oxygen content may, depending on the added element amount and the S content, be higher than 2 massppm and be 400 massppm, in the range of having the properties of the alloy.

The S content is preferably 2 to 12 massppm, more preferably 3 to 8 massppm.

The soft dilute copper alloy material according to the invention is configured as a soft copper material which satisfies an electrical conductivity of not lower than 98% IACS (International Annealed Copper Standard, when it is 100% at a resistivity of 1.7241×10⁻⁸ Ωm), preferably not lower than 100% IACS, more preferably not lower than 102% IACS.

According to the invention, for the case of producing the soft copper material with an electrical conductivity of not lower than 98% IACS, it is preferred to use a soft dilute copper alloy material containing 3 to 12 massppm of sulfur, higher than 2 massppm and not more than 30 massppm of oxygen, and 4 to 55 massppm of titanium in combination with the inevitable impurity-containing pure copper as a base material. A wire rod or soft dilute copper alloy plate is fabricated from this soft dilute copper alloy material.

Here, for the case of producing the soft copper material with an electrical conductivity of not lower than 100% IACS, it is preferred to use a soft dilute copper alloy material containing 2 to 12 massppm of sulfur, higher than 2 massppm and not more than 30 massppm of oxygen, and 4 to 37 massppm of titanium in combination with the inevitable impurity-containing pure copper as the base material.

In addition, for the case of producing the soft copper material with an electrical conductivity of not lower than 102% IACS, it is preferred to use the soft dilute copper alloy material containing 3 to 12 massppm of sulfur, higher than 2 massppm and not more than 30 massppm of oxygen, and 4 to 25 massppm of titanium in combination with the inevitable impurity-containing pure copper as the base material.

Typically, in the industrial manufacture of pure copper, it is difficult to suppress the sulfur content to be not more than 3 massppm since sulfur is taken in copper in the manufacture of electrolytic copper. The upper limit of sulfur concentration in commodity copper is 12 massppm.

Since the oxygen content is higher than 2 massppm and not more than 30 massppm, this embodiment is directed to a so-called low-oxygen copper (LOC).

The oxygen concentration is controlled to be higher than 2 massppm, since the hardness of the copper conductor is unlikely to lower if the oxygen concentration is lower than 2 massppm. Also, the oxygen concentration is controlled to be not more than 30 massppm, since a hot rolling step tends to cause the copper conductor to have surface flaws if the oxygen concentration is higher than 30 massppm.

(3) Crystalline Texture

The soft dilute copper alloy wire and soft dilute copper alloy plate according to the invention have a crystalline texture that an average size of copper conductor crystal grains lying from a surface of the wire or plate to a depth of 20% of a diameter of the wire or a thickness of the plate is not greater than 20 μm.

It is because the tensile strength and elongation rate of the material can be expected to be enhanced by the presence of the fine crystal grains, especially those of the surface layer. The reason for this is considered to be because local strain caused adjacent to grain boundaries by tensile deformation becomes smaller with finer crystal grain diameter, to contribute to the mitigation of intergranular stress concentration, thereby reductive the intergranular stress concentration and suppressing the intergranular fracture.

In addition, in the invention, the limitation “crystalline texture that an average size of copper conductor crystal grains lying from a surface of the soft dilute copper alloy wire or plate to a depth of 20% of a diameter of the wire or a thickness of the plate is not greater than 20 μm is not intended to exclude presence of a fine crystal layer in a region closer to the center of the wire rod beyond the depth of 20% of the wire diameter or the plate thickness, as long as the wire or plate has the advantageous effect of the invention.

(4) Dispersed Substances

It is preferred that the size of particles dispersed in the soft dilute copper alloy material is small, and it is also preferred that many particles are dispersed in the soft dilute copper alloy material. The reason for this is because the dispersed particles act as sulfur precipitation sites, and because a large number of the dispersed particles are required due to the size of the dispersed particles being small for the precipitation sites.

Specifically, sulfur and titanium as the additive element contained in the soft dilute copper alloy wire and soft dilute copper alloy plate is contained as TiO, TiS or a compound having a Ti—O—S bond or an aggregate of TiO, TiO₂, TiS or a compound having a Ti—O—S bond, and Ti and S of the balance are contained as a solid solution. In addition, the other additive elements are also contained in the same manner as titanium.

The dispersed particle formation and the sulfur precipitation to the dispersed particles enhances the purity of the copper matrix, contributing to enhancement of the electrical conductivity and reduction of the hardness of the material.

(5) The Hardness, Elongation and Tensile Strength of the Soft Dilute Copper Alloy Material

The soft dilute copper alloy material according to the invention is required to be excellent in the balance between the tensile strength and the elongation rate. The reason for this is because, e.g., in the case of a conductor whose elongation rate value is the same, when its tensile strength is high, it is possible to reduce the occurrence of a wire break due to stress being caused by bending, torsion, etc. Further, when the soft dilute copper alloy material having the softness in addition to the tensile strength and the elongation is applied to, for example, a bonding wire, it is possible to reduce damage to an Al wiring film used as a bonding pad and its underlying Si semiconductor chip. Further, when the tensile strength and elongation of the wire itself are great, it is easy to hold a proper wire loop, or suppress the occurrence of a neck break at a ball-wire bonding boundary, or a wire break when bonding the wire to a wire bonding portion.

Typically, because there is a trade-off between the tensile strength and elongation, and the hardness (softness), it is desired to balance these properties. Here, the hardness means Vickers hardness of the material.

The balance between the tensile strength, elongation rate, and hardness of the soft dilute copper alloy material according to the invention is as follows, though specifications required by products are slightly different. According to the invention, for a copper bonding wire conductor as one example, if importance is placed on the tensile strength, it is possible to provide a conductor having a tensile strength of not less than 270 MPa, an elongation rate of not less than 7%, and a hardness of not more than 65 Hv. Also, if importance is placed on the hardness, it is possible to provide a conductor having a tensile strength of 210 MPa to less than 270 MPa, an elongation rate of not less than 15%, and a hardness of not more than 63 Hv.

In addition, it is desirable that the soft dilute copper alloy material according to the invention has the elongation rate which is the same as or more than that of an annealed oxygen-free copper wire, and the tensile strength which is not less than 2 MPa higher than the oxygen-free copper wire.

(Production Method of the Soft Dilute Copper Alloy Material)

A producing method for the soft dilute copper alloy wire and the soft dilute copper alloy plate according to the invention is as follows. As an example, a case of selecting Ti as the additive element is described.

First, as a raw material for the soft dilute copper alloy wire/plate, a Ti containing soft dilute copper alloy material is prepared (raw material preparation step). Next, a molten metal is formed from this soft dilute copper alloy material at a molten copper temperature of not lower than 1100° C. and not higher than 1320° C. (molten metal producing step). Then, a wire rod is produced from the molten metal (wire rod producing step). Subsequently, the wire rod is hot rolled at a temperature of not lower than 880° C. to not higher than 550° C. (hot rolling step). Further, the wire rod after the hot rolling step is drawn and heated (wire drawing and heating step). The heating method may use tube furnace annealing or resistive heating annealing. Or, batch annealing is also possible. This results in the soft dilute copper alloy material according to the invention.

Also, in the production of the soft dilute copper alloy wire/plate, 2 massppm to 12 massppm of sulfur, higher than 2 massppm and not more than 30 massppm of oxygen, and not lower than 4 massppm and not higher than 55 massppm of titanium are used.

In order to realize the lowering of the hardness of the conductor copper and the enhancement of the electrical conductivity of the conductor copper, the inventors studied the following two solutions. And, by using the following two solutions together in the copper wire rod production, it is possible to produce the soft dilute copper alloy wire/plate according to the invention.

First, the first solution is to produce a molten copper metal, with titanium (Ti) added to pure copper containing an oxygen concentration of higher than 2 massppm. It is considered that, in this molten copper metal, TiS, titanium oxide (e.g., TiO₂) and Ti—O-S particles are formed.

Next, the second solution is to set the hot rolling temperature to a temperature (880° C. to 550° C.) lower than a temperature (i.e., 950° C. to 600° C.) in normal copper production conditions, for the purpose of introducing a dislocation in copper and thereby facilitating sulfur (S) precipitation. Such temperature setting allows the S precipitation onto the dislocation, or the S precipitation with a titanium oxide (e.g., TiO₂) as a nucleus.

With the first solution and the second solution, since the sulfur contained in the copper crystallizes and precipitates, the copper wire rod having the desired softness property and desired electrical conductivity can be produced after cold wire drawing.

The soft dilute copper alloy wire/plate according to the invention uses an SCR continuous casting facility, and has few surface flaws, and its production range is wide, and its stable production is possible.

The copper wire rod is produced by SCR continuous casting rolling at a processing degree of the ingot rod of 90% (30 mm) to 99.8% (5 mm). As one example, conditions for producing the wire rod having a diameter of 8 mm at a processing degree of 99.3% are employed.

The molten copper temperature in a melting furnace is preferably controlled to be not lower than 1100° C. and not higher than 1320° C. The molten copper temperature is controlled to be not higher than 1320° C. because if it is higher than 1320° C., blow holes tend to increase in number, resulting in flaws, and increases in particle size. In addition, the molten copper temperature is controlled to be not lower than 1100° C. and is desirable to be as low as possible, because copper tends to solidify and is not stable in production.

The hot rolling temperature is preferably controlled to be not higher than 880° C. in initial rolling, and not lower than 550° C. in final rolling.

These casting conditions are different from typical pure copper producing conditions, and are intended to make smaller the solid solubility limit which is a driving force for sulfur crystallization in molten copper and sulfur precipitation during hot rolling.

In addition, although the normal hot rolling temperature is not higher than 950° C. in initial rolling, and not lower than 600° C. in final rolling, it is desirable that, in the invention, the hot rolling temperature be set to be not higher than 880° C. in initial rolling, and not lower than 550° C. in final rolling.

Incidentally, the reason for setting the final rolling temperature to not lower than 550° C. is because the wire rod produced at a temperature of less than 550° C. have many flaws, and the copper conductor produced cannot be treated as a product. The hot rolling temperature is preferably controlled to be not higher than 880° C. in initial rolling, and not lower than 550° C. in final rolling, and is preferably as low as possible. Such temperature settings allow enhancement in the matrix purity of the soft dilute copper alloy wire/plate, thus ensuring enhancement of its electrical conductivity and reduction of its hardness.

It is preferred that the pure copper base material is passed through a gutter in a reductive state after being melted in a shaft furnace. In other words, it is preferred that in a reductive gas (e.g., CO gas) atmosphere, the material is casted with the sulfur concentration, titanium concentration and oxygen concentration in the dilute alloy being controlled, and is rolled to thereby produce stably the wire rod. It should be noted that copper oxide contamination and/or the particle size greater than a predetermined size degrades the quality of the copper conductor produced.

This can result in the soft copper alloy material with the well-balanced elongation property, tensile strength, and Vickers hardness, as the raw material for the soft dilute copper alloy wire, and the soft dilute copper alloy plate according to the invention.

It is also possible to form a plating layer on the surface of the soft dilute copper alloy material. The plating layer may use, for example, a material composed mainly of a noble metal such as palladium, zinc, nickel, gold, platinum, silver, etc., or Pb-free plating. In addition, the shape of the soft dilute copper alloy material is not particularly limited, but may be a round cross-sectional shape, rod shape, or rectangular conductor shape.

In addition, in the invention, the wire rod can be made by SCR (South Continuous Rod System) continuous casting rolling method, and the soft material can be made by hot rolling, but twin roll continuous casting continuous casting rolling or Properzi continuous casting continuous casting rolling is also employed.

### EXAMPLES

### Example 1

(Production of the Soft Dilute Copper Alloy Material)

As an experimental material, an 8 mm diameter copper wire (wire rod, processing degree 99.3%) containing a titanium concentration of 13 massppm in a low-oxygen copper (oxygen concentration of 7 massppm to 8 massppm, sulfur concentration of 5 massppm) is fabricated. The 8 mm diameter copper wire is fabricated by hot rolling with the SCR continuous casting rolling method. A molten copper in a shaft furnace is passed to a gutter in a reductive gas atmosphere, and the molten copper passed to the gutter is guided to a casting pot in the same reductive gas atmosphere. After adding Ti in this casting pot, an ingot rod is created in a mold formed between a casting wheel and an endless belt through a nozzle. This ingot rod is hot rolled to create the 8 mm diameter copper wire. Then, each experiment wire material is cold drawn. It results in the 2.6 mm diameter size soft dilute copper alloy wire. Its properties are verified.

(The Softness Property of the Soft Dilute Copper Alloy Wire)

Table 1 shows verified results of Vickers hardness (Hv) after annealing for 1 hour at different annealing temperatures, for comparative material 1 using an oxygen-free copper wire, and example material 1 using a soft dilute copper alloy wire containing 13 massppm of Ti in a low oxygen copper. Table 1 shows that comparative material 1 and example material 1 are on the same level in Vickers hardness (Hv) at the annealing temperature of 400° C. and that are on the same level in Vickers hardness (Hv) at the annealing temperature of 600° C. as well. From this, it is found that the soft copper alloy wire of the invention has the sufficient softness property, and particularly has the excellent softness property in a region at the annealing temperatures higher than 400° C., even in comparison with the oxygen-free copper wire.

TABLE 1

| Sample | 20° C. | 400° C. | 600° C. |
|---|---|---|---|
| Example material 1 | 120 | 52 | 48 |
| Comparative material 1 | 124 | 53 | 56 |

(Unit: Hv)

(The Crystal Structure of the Soft Dilute Copper Alloy Wire)

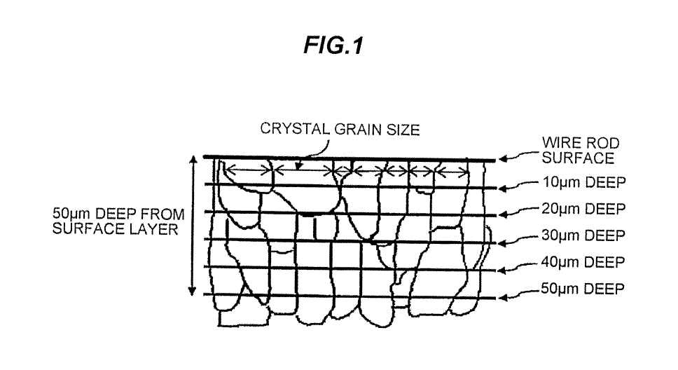

For 2.6 mm diameter example material 1, and 2.6 mm diameter comparative material 1, an average crystal grain size in a surface layer is measured. Here, in the method of measuring the average crystal grain size in the surface layer, as shown in FIG. 1, the average crystal grain size in the surface layer is an average of crystal grain size values each measured at a depth direction pitch of 10 μm from a surface to a depth of 50 μm at a 2.6 mm diameter cross section in a wire length range of 10 mm.

As a result of the measurement, the average crystal grain size in the surface layer of example material 1 is 20 μm, whereas the average crystal grain size in the surface layer of comparative material 1 is 100 μm. Therefore, in the invention, the average crystal grain size in the surface layer from the surface to 20% of the depth is not greater than 20 μm.

In the crystal structure of example material 1, its crystal grain size in a thin layer formed adjacent to the surface in the cross-sectional direction of the sample is very small compared to its internal crystal grain size, whereas in the crystal structure of comparative material 1, overall equal-size crystal grains are arranged homogeneously from the surface to the center.

The upper limit of the average crystal grain size in the surface layer to exhibit the advantageous effects of the invention is not greater than 20 μm, and preferably not less than 5 μm from a limit value in production.

(A Relationship Between the Elongation Property and the Crystal Structure of the Soft Dilute Copper Alloy Wire)

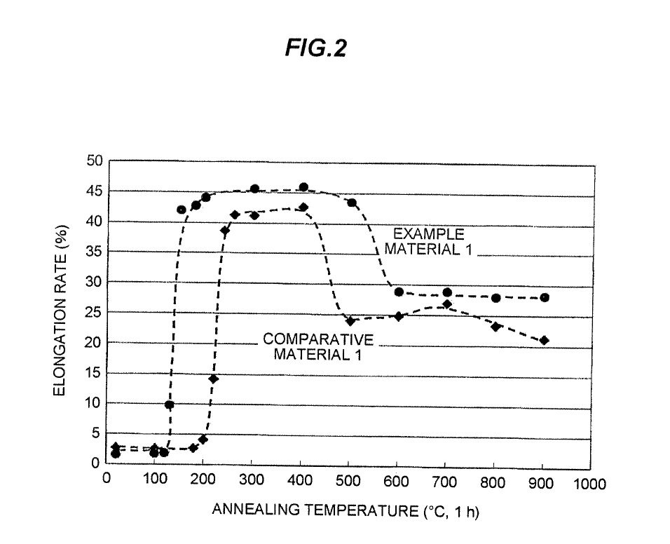

FIG. 2 is a graph showing elongation (%) value changes verified after annealing for 1 hour at different annealing temperatures, for a sample of comparative material 1 using a 2.6 mm diameter oxygen-free copper wire, and a sample of example material 1 using a 2.6 mm diameter soft dilute copper alloy wire containing 13 massppm of Ti added in a low oxygen copper (oxygen concentration of 7 massppm to 8 massppm, sulfur concentration of 5 massppm). A circle shown in FIG. 2 represents example material 1, and a square represents comparative material 1.

As shown in FIG. 2, it is found that example material 1 shows the excellent elongation property in a wide annealing temperature range exceeding 100° C., from around 130° C. to 900° C., in comparison to comparative material 1.

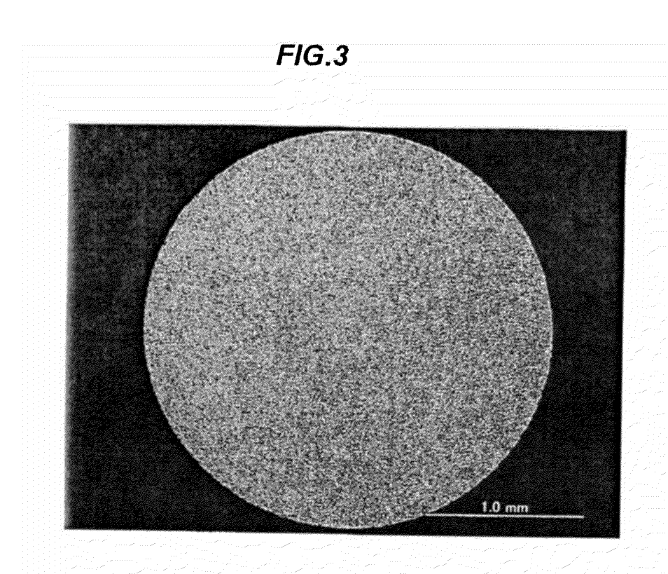

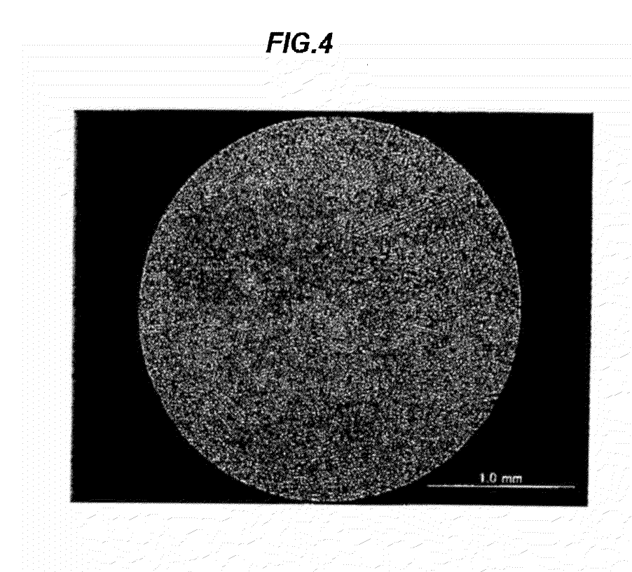

FIG. 3 shows a cross-sectional photograph in a radial direction of the copper wire of example material 1 at an annealing temperature of 500° C. Referring to FIG. 3, the resulting crystalline texture is fine in the entire cross section of the copper wire, and this fine crystalline texture is considered to have contributed to the elongation property. In contrast, in the cross-sectional texture of comparative material 1 at an annealing temperature of 500° C. secondary recrystallization progressed, and the elongation property is considered to have lowered due to crystal grain coarsening in the cross-sectional texture, in comparison to the crystalline texture of FIG. 4.

FIG. 4 shows a cross-sectional photograph of the copper wire of example material 1 at an annealing temperature of 700° C. It is found that the crystal grain size in the surface layer in the cross section of the copper wire is very small compared to the internal crystal grain size. Although in the internal crystalline texture, secondary recrystallization progressed, an outer layer of fine crystal grains remained. Example material 1 is considered to have maintained its elongation property, because the layer of fine crystal grains remained in the surface layer, though the internal crystalline texture significantly grew.

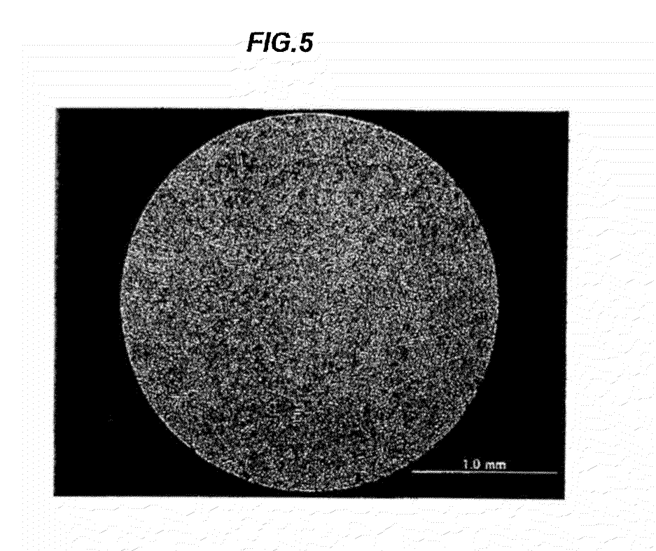

FIG. 5 shows a cross-sectional texture in a radial direction of comparative material 1, whose elongation property in a high-temperature region at 600° C. or higher is considered to have lowered due to overall substantially equal-size crystal grains arranged homogeneously from the surface to the center, and secondary recrystallization progressing in the entire cross-sectional texture.

From the results described above, the product using example material 1 is soft, and is enhanced in electrical conductivity, and can be enhanced in elongation property, compared to comparative material 1.

With a conventional conductor, in order to recrystallize its crystalline texture to have such a size as that of example material 1, high-temperature annealing is required. However, if the annealing temperature is too high, S re-forms a solid solution. In addition, there is the problem that the conventional conductor is soft and lowers its elongation property due to recrystallization. However, example material 1 has the following properties: When annealed, it can be recrystallized without being twinned. Therefore, its internal crystal grains are large and soft. On the other hand, because fine crystal grains remain in the surface layer, the tensile strength and the elongation property do not lower. By using example material 1 for the copper conductor, it is possible to realize the copper conductor being small in hardness, high in electrical conductivity, and excellent in elongation property, and having a later-described excellent tensile strength.

### Example 2

(0.05 mm Diameter Soft Dilute Copper Alloy Wire)

A 2.6 mm diameter size copper wire is made in the same manner as in example 1 of the soft dilute copper alloy material described above. This wire is drawn to have a diameter of 0.9 mm, annealed by resistive heating, and subsequently drawn to have a diameter of 0.05 mm.

This 0.05 mm diameter wire is annealed at a winding speed of 500 m/min by resistive heating at a voltage of 21 to 33V, resulting in example material 2. For comparison, a 0.05 mm diameter oxygen-free copper (with purity of 99.99% or more, OFC) wire is made in the same heating conditions, resulting in comparative material 2.

As another annealing method, a soft dilute copper alloy material drawn from a diameter of 0.9 mm to a diameter of 0.05 mm in the same manner as described above is annealed at 400 to 600° C.×0.8 to 4.8 seconds (i.e. for 0.8 to 4.8 seconds) in a tube furnace, resulting in example material 2. For comparison, a 0.05 mm diameter oxygen-free copper (with purity of 99.99% or more, OFC) is made in the same heating conditions, resulting in comparative material 2.

For these materials, the mechanical properties (tensile strength, elongation), hardness, and crystal grain size are measured. For an average crystal grain size in the surface layer, the crystal grain size is measured at a depth of 10 μm from a surface at a 0.05 mm diameter width direction cross section in a wire length range of 0.025 mm.

(Softness Property, Elongation and Tensile Strength of the Copper Conductor)

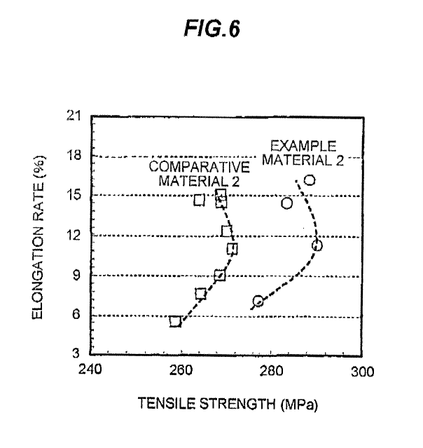

FIG. 6 shows measured results of the cross-section hardness (Hv) and the mechanical properties (tensile strength, elongation) after the drawing from a diameter of 0.9 mm (annealed material) to a diameter of 0.05 mm and the subsequent resistive heating annealing (voltage 21 to 33V, winding speed 500 m/min), for a wire rod of comparative material 2 using the oxygen-free copper wire, and a wire rod of example material 2 made from the soft dilute copper alloy wire containing 13 massppm of Ti in the low oxygen copper.

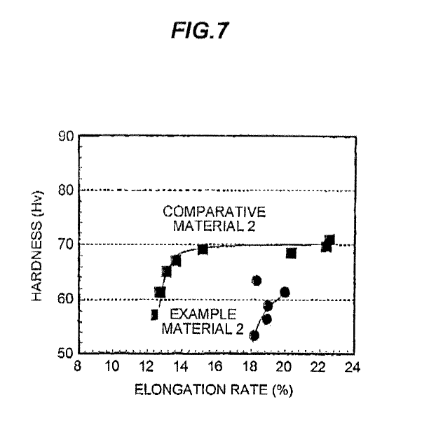

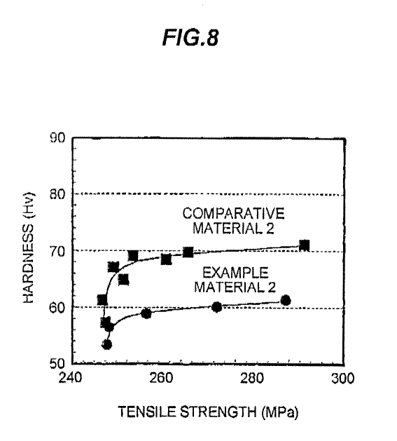

FIGS. 7 and 8 show measured results of the cross-section hardness (Hv) and the mechanical properties (tensile strength, elongation) after the drawing from a diameter of 0.9 mm (annealed material) to a diameter of 0.05 mm and the subsequent tube furnace annealing (temperature of 400 to 600° C., time period of 0.8 to 4.8 seconds), for a wire rod of comparative material 2 using the oxygen-free copper wire, and a wire rod of example material 2 made from the soft dilute copper alloy wire containing 13 massppm of Ti in the low oxygen copper.

The cross-section hardness is evaluated by polishing the transverse cross-section of the 0.05 mm diameter wire embedded in a resin, and measuring the Vickers hardness at the center of the wire. The number of measurements is n=5, and its average is taken.

The tensile strength and elongation measurements are evaluated by a tensile test of the 0.05 mm diameter wire in conditions of a gauge length of 100 mm, and a tensioning speed of 20 mm/min. The tensile strength is a maximum tensile stress at the time of fracture of the material, and the elongation is a maximum deformation amount (strain) at the time of fracture of the material.

As shown in FIG. 7, it is found that when compared at substantially the same elongation rate, the tensile strength of example material 2 is not less than 15 MPa greater than that of comparative material 2. In comparison with the oxygen-free copper, the elongation is not lowered, but the tensile strength can be high. Therefore, the copper conductor of example material 2 can, for example, reduce the occurrence of a wire break due to stress caused, in comparison to the copper conductor using the oxygen-free copper wire.

Table 2 shows compared results of data of example material 2 and comparative material 2 being in substantially the same hardness condition, selected from among the evaluated results shown in FIG. 7. In Table 3, the upper row for the Example material 2 shows the mechanical properties and the hardness of the wire rod of example material 2 when drawn from a diameter of 0.9 mm (annealed material) to a diameter of 0.05 mm and annealed at 400° C.×1.2 seconds (i.e. for 1.2 seconds) in the tube furnace. Likewise, the lower row for Comparative material 2 in Table 3 shows the mechanical properties and the hardness of the wire rod of comparative material 2 when drawn from a diameter of 0.9 mm (annealed material) to a diameter of 0.05 mm and annealed at 600° C.×2.4 seconds (i.e. for 2.4 seconds) in the tube furnace.

TABLE 2

| | Tensile | Elongation | Vickers |
|---|---|---|---|
| | strength | rate | hardness |
| Sample | (MPa) | (%) | (Hv) |
| Example material 2 | 213 | 18 | 53 |
| Comparative material 2 | 211 | 13 | 61 |

As shown in Table 2, the elongation of example material 2 is not less than 7% higher than that of comparative material 2, even though the materials have the same hardness. Therefore, for example, using example material 2 as a bonding wire allows greatly contributing to enhancement in connection reliability and handling properties at the time of wire bonding. In addition, the bonding wire of example material 2 is high in the tensile strength, in comparison to a bonding wire using the oxygen-free copper wire, even though having the same hardness. Therefore, the bonding wire of example material 2 can greatly contribute to reliability in strength of a connecting portion (ball neck).

Here, the connection reliability in wire bonding portion refers to resistance to stress caused by a difference in thermal expansion between the copper wire and resin material, after wire bonding and subsequent resin molding. Also, the handling properties refer to resistance to stress caused at the time of providing the wire from a wire spool to the bonding portion, and resistance to curling.

Then, from FIG. 8, it is found that when compared at substantially the same tensile strength, the hardness of example material 2 is smaller by 10 Hv than that of comparative material 2. The tensile strength is not lowered, but the hardness can be small. Therefore, for example, using the conductor of example material 2 as a bonding wire allows reducing damage to a pad at the time of bonding.

Table 3 shows compared results of data of example material 2 and comparative material 2 being in substantially the same tensile strength condition, selected from among the evaluated results shown in FIG. 7. In Table 4, the upper row for the Example material 2 shows the mechanical properties and the hardness of the wire rod of example material 2 when drawn from a diameter of 0.9 mm (annealed material) to a diameter of 0.05 mm and annealed at 500° C.×4.8 seconds (i.e. for 4.8 seconds) in the tube furnace. Likewise, the lower row for Comparative material 2 in Table 4 shows the mechanical properties and the hardness of the wire rod of comparative material 2 when drawn from a diameter of 0.9 mm (annealed material) to a diameter of 0.05 mm and annealed at 600° C.×2.4 seconds (i.e. for 2.4 seconds) in the tube furnace.

TABLE 3

| | Tensile | Elongation | Vickers |
|---|---|---|---|
| | strength | rate | hardness |
| Sample | (MPa) | (%) | (Hv) |
| Example material 2 | 279 | 20 | 61 |
| Comparative material 2 | 211 | 13 | 61 |

As shown in Table 3, the elongation of example material 2 is higher by 5% than that of comparative material 2, even though the materials have the same tensile strength. Therefore, for example, using example material 2 as a bonding wire allows greatly contributing to enhancement in connection reliability and handling properties at the time of wire bonding. In addition, the hardness of example material 2 is sufficiently smaller than that of comparative material 2, even though the materials have the same tensile strength. Therefore, using the conductor of example material 2 as a bonding wire allows reducing damage to a pad at the time of bonding.

The balance between the tensile strength, elongation, and hardness is as follows, though specifications required by products are slightly different. According to the invention, as one example, if importance is placed on the tensile strength, it is possible to provide a conductor having a tensile strength of not less than 270 MPa, an elongation rate of not less than 7%, and a hardness of not more than 65 Hv. In addition, since the hardness is small, it is possible to provide a conductor having a tensile strength of 210 MPa to less than 270 MPa, an elongation rate of not less than 15%, and a hardness of not more than 63 Hv.

(The Crystal Structure of the 0.05 mm Diameter Soft Dilute Copper Alloy Wire)

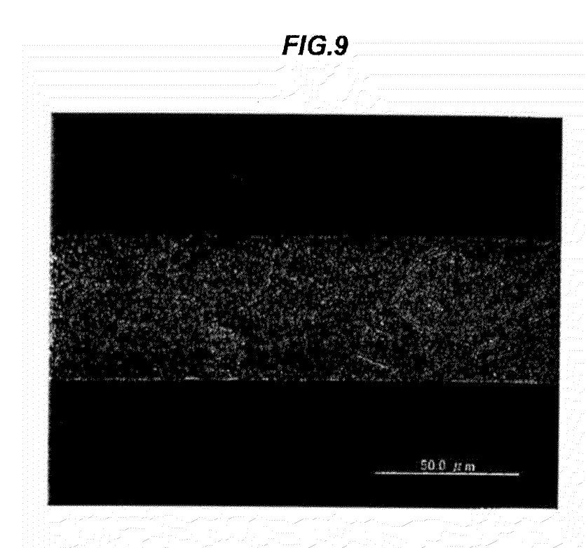

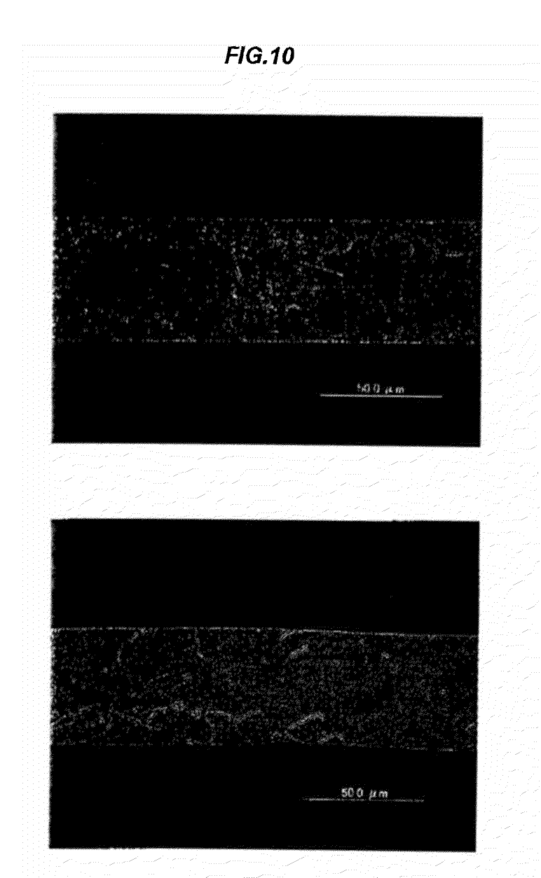

FIG. 9 shows a texture at a width direction cross section of comparative material 2, and FIG. 10 shows a texture at a width direction cross section of example material 2. As shown in FIG. 9, it can be seen that in the crystal structure of comparative material 2, overall equal-size crystal grains are arranged homogeneously from the surface to the center. On the other hand, in the crystal structure of example material 2, the crystal grain size is overall sparse, and the crystal grain size in a thin layer formed adjacent to the surface in the cross-sectional direction of the sample is very small, compared to the internal crystal grain size.

The inventors consider that the fine crystal grain layer having appeared in the surface layer that was not formed in comparative material 2 contributes to having the softness property of example material 2, and having both the tensile strength and the elongation property.

Typically, it is understood that heat treatment for the purpose of softening causes homogeneously coarsened crystal grain formation due to recrystallization as in comparative material 2. However, in example material 2, the fine crystal grain layer remains in the surface layer, even when annealed to form coarse crystal grains inside. Therefore, it is considered that, with example material 2, the soft dilute copper alloy material is produced that is excellent in tensile strength and elongation, though being the soft copper material.

In addition, based on cross-sectional photographs of crystal structures shown in FIGS. 9 and 10, an average crystal grain size in the surface layer is measured for samples of example material 2 and comparative material 2.

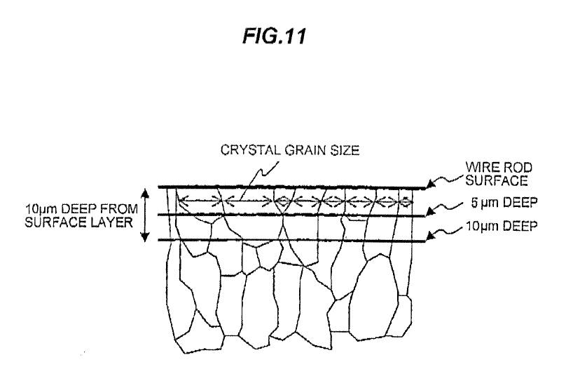

FIG. 11 shows a schematic method of measuring the average crystal grain size in the surface layer. As shown in FIG. 11, crystal grain sizes are measured at a depth direction pitch of 5 μm from a surface to a depth of 10 μm at a 0.05 mm diameter width direction cross section in a wire length range of 0.25 mm. Then, from each measured value, average values are obtained. This average values are the average crystal grain sizes.

As a result of the measurement, the average crystal grain sizes in the surface layer of comparative material 2 are 22 μm. In contrast, the average crystal grain sizes in the surface layer of example material 2 are as different as 7 μm and 15 μm. The average crystal grain sizes in the surface layer of example material 2 are fine. This is considered to be one reason for the high tensile strength and elongation of example material 2. Incidentally, if the crystal grain sizes are large, cracking develops along crystal grain boundaries. However, if the crystal grain sizes are small, the crack developing direction changes, and therefore the crack developing can be suppressed. From this, the fatigue property of example material 2 is considered to be more excellent than that of comparative material 2. The fatigue property refers to the number of stressing cycles or time period until material fracture due to repeated stressing.

To exhibit the advantageous effect of this embodiment, is preferred that the average crystal grain size in the surface layer is not greater than 15 μm.

### Example 3

(The Crystal Structure at an Annealing Temperature of 600° C. of the 0.26 mm Diameter Copper Bonding Wire)

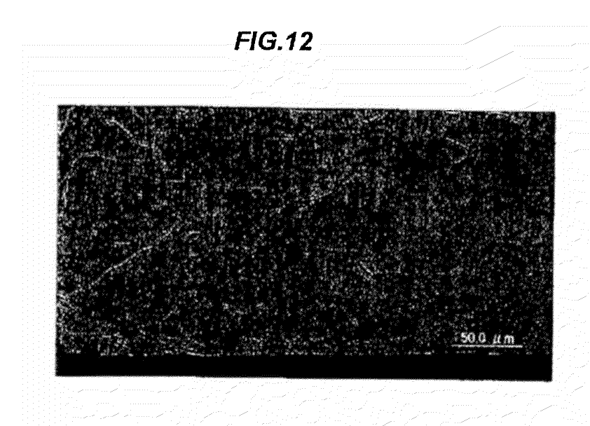

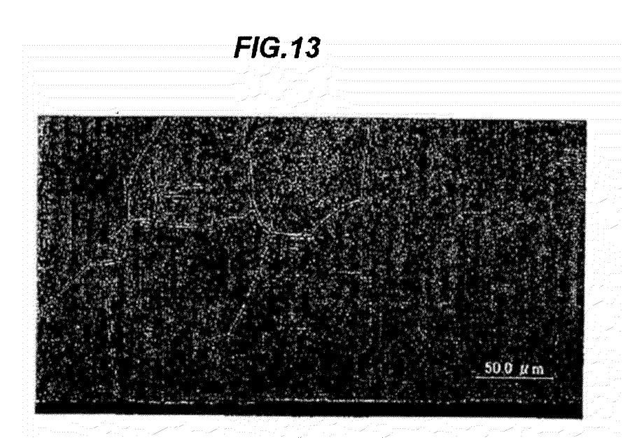

FIG. 12 is a cross-sectional photograph showing a cross-sectional texture in a wire width direction of example material 3 having the same composition as example material 1, and using a 0.26 mm diameter wire rod annealed at 600° C. annealing temperature for 1 hour, and FIG. 13 is a cross-sectional photograph showing a cross-sectional texture in a wire width direction of comparative material 3 having the same composition as comparative material 1, and using a 0.26 mm diameter wire rod annealed at 600° C. annealing temperature for 1 hour.

Referring to FIGS. 12 and 13, there are shown crystal structures of example material 3 and comparative material 3. As shown in FIGS. 12 and 13, it can be seen that in the crystal structure of comparative material 3, overall equal-size crystal grains are arranged homogeneously from the surface to the center. In contrast, in the crystal structure of example material 3, the crystal grain size is overall sparse, and it is noteworthy that the crystal grain size in a thin layer formed adjacent to the surface in the cross-sectional direction of the wire is very small, compared to the internal crystal grain size.

The inventors consider that the fine crystal grain layer having appeared in the surface layer that was not formed in comparative material 3 contributes to enhancement in the tensile strength and the elongation property of example material 3.

Typically, it is understood that annealing at 600° C. annealing temperature for 1 hour causes homogeneously coarsened crystal grain formation due to recrystallization as in comparative material 3. However, in the case of example material 3, the fine crystal grain layer still remains in its surface layer, even when annealed at 600° C. annealing temperature for 1 hour. Therefore, it is considered that, with example material 3, the soft dilute copper alloy material is produced that allows realization of the excellent tensile strength and elongation property of the copper conductor, though being the soft copper material.

And, based on cross-sectional photographs of crystal structures shown in FIGS. 12 and 13, an average crystal grain size in the surface layer is measured for example material 3 and comparative material 3. Here, as shown in FIG. 1, the average crystal grain size in the surface layer is an average of crystal grain size values each measured at a depth direction pitch of 10 μm from a surface to a depth of 50 μm at a 2.6 mm diameter cross section in a wire length range of 1 mm.

As a result of the measurement, the average crystal grain size in the surface layer of comparative material 3 is 50 μm. In contrast, the average crystal grain size in the surface layer of example material 3 is 10 μm which is significantly different from that of comparative material 3. The average crystal grain sizes in the surface layer of example material 3 are fine. This is considered to allow realization of the excellent tensile strength and elongation property of the copper conductor.

### Example 4

(The Crystal Structure at an Annealing Temperature of 400° C. of the 0.26 mm Diameter Copper Bonding Wire)

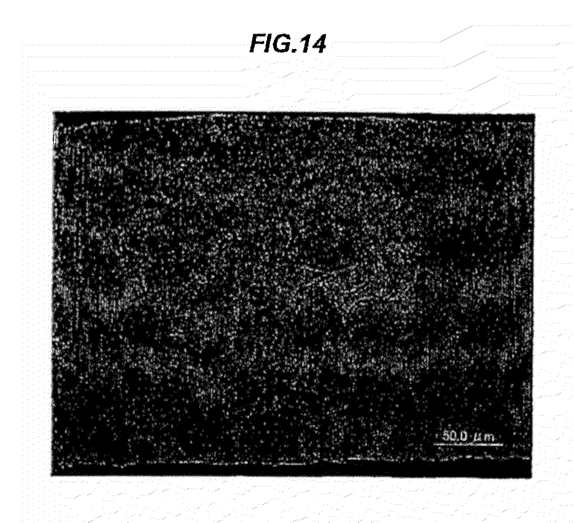

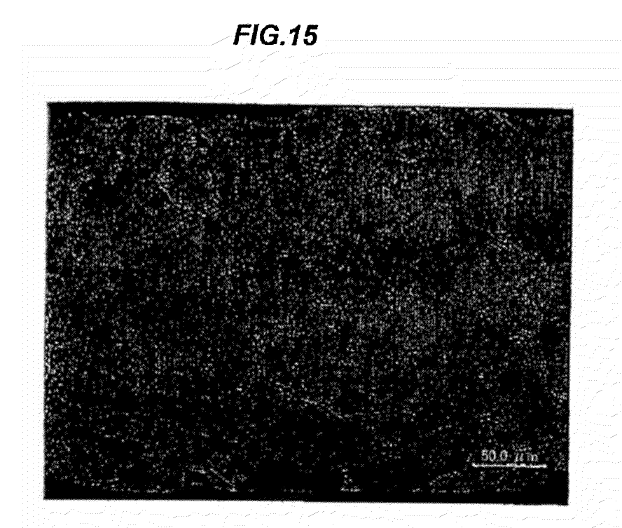

FIG. 14 is a cross-sectional photograph showing a cross-sectional texture in a width direction of a sample of example material 4, and FIG. 15 is a cross-sectional photograph showing a cross-sectional texture in a width direction of comparative material 4.

Example material 4 is a 0.26 mm diameter soft dilute copper alloy wire with 7 massppm to 8 massppm of oxygen concentration, 5 massppm of sulfur concentration, and 13 massppm of titanium concentration, and is fabricated by annealing at 400° C. annealing temperature for 1 hour.

Comparative material 4 is a 0.26 mm diameter wire rod formed of oxygen-free copper wire (OFC), and is fabricated by annealing at 400° C. annealing temperature for 1 hour.

As shown in FIGS. 14 and 15, it can be seen that in the crystal structure of the comparative material 4, overall equal-size crystal grains are arranged homogeneously from the surface to the center. In contrast, in the crystal structure of example material 4, the crystal grain sizes in the surface layer are different from the internal crystal grain sizes, i.e. the internal crystal grain sizes are very large compared to the crystal grain sizes in the surface layer.

When the crystalline texture is recrystallized by copper annealing, the recrystallization of example material 4 tends to progress, and the internal crystal grains of example material 4 grow significantly.

Next, Table 4 shows the electrical conductivity of example material 4 and comparative material 4.

TABLE 4

| | Soft material electrical conductivity |
|---|---|
| | (% IACS) |
| Example material 4 | 102.4 |
| Comparative material 4 | 101.8 |

As shown in Table 4, the electrical conductivity of example material 4 is slightly greater than or substantially equal to the electrical conductivity of the comparative material 4, and can be satisfied for wire bonding.

With the soft dilute copper alloy wire in the above embodiment, in the soft dilute copper alloy material containing Ti, etc. and the balance being comprising copper, because of such a crystalline texture that the average size of the crystal grains lying from the surface to the depth of 20% of the wire diameter is not greater than 20 μm, it is possible to make the high tensile strength and elongation compatible, achieve the high electrical conductivity, and therefore enhance the connection reliability for products.

Also, because as with Ti added, an additive element selected from the group consisting of Mg, Zr, Nb, Ca, V, Ni, Mn and Cr traps the sulfur (S) impurity, the copper parent phase matrix is high in purity, and the softness property of the material can be enhanced. For this, especially use for bonding has the advantageous effect of being able to suppress damage to a fragile aluminum pad on a silicon chip during bonding.

Also, the soft dilute copper alloy material in this embodiment can be low-cost because no high purity (purity of 99.999 mass % or more) copper processing is required, but the high electrical conductivity can be realized with the inexpensive continuous casting rolling method.

In addition, in the case of using the soft dilute copper alloy material in this embodiment for a copper bonding wire, it can also be applied as an alternative to an approximately 0.3 mm diameter Al bonding wire for use in an on-vehicle power module, and the connection reliability lowering due to current density increasing can be avoided because module miniaturization results from wire diameter being decreased by high thermal conductivity of the material, and heat dissipation is increased by the thermal conductivity enhancement.

In addition, in this embodiment, the wire rod is shown, but a similar advantageous effect can also be obtained in a thin plate as in the wire rod.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A soft dilute copper alloy wire, comprising
a soft dilute copper alloy material containing an additive element selected from a group consisting of Ti, Mg, Zr, Nb, Ca, V, Ni, Mn, and Cr, and balance comprising Cu,
wherein an average size of crystal grains lying from a surface of the soft dilute copper alloy wire at least to a depth of 20% of a wire diameter is not greater than 20 μm.

2. The soft dilute copper alloy wire according to claim 1, further containing:
higher than 2 massppm of oxygen; and
2 massppm to 12 massppm of sulfur.

3. The soft dilute copper alloy wire according to claim 1, wherein
a tensile strength is not less than 210 MPa;
an elongation rate is not less than 15%; and
a Vickers hardness is not more than 65 Hv.

4. The soft dilute copper alloy wire according to claim 1, wherein
an electrical conductivity is not lower than 98% IACS.

5. The soft dilute copper alloy wire according to claim 1, containing:
4 massppm to 55 massppm of Ti as the additive element; and
higher than 2 massppm and not more than 30 massppm of oxygen.

6. A soft dilute copper alloy plate, comprising:
a soft dilute copper alloy material containing an additive element selected from a group consisting of Ti, Mg, Zr, Nb, Ca, V, Ni, Mn, and Cr, and balance comprising Cu,
wherein an average size of crystal grains lying from a surface of the soft dilute copper alloy plate at least to a depth of 20% of a plate thickness is not greater than 20 μm.

7. The soft dilute copper alloy plate according to claim 6, further containing:
higher than 2 massppm of oxygen; and
2 massppm to 12 massppm of sulfur.

8. The soft dilute copper alloy plate according to claim 6, wherein
a tensile strength is not less than 210 MPa;
an elongation rate is not less than 15%; and
a Vickers hardness is not more than 65 Hv.

9. The soft dilute copper alloy plate according to claim 6, wherein
an electrical conductivity is not lower than 98% IACS.

10. The soft dilute copper alloy plate according to claim 6, containing:
4 massppm to 55 massppm of Ti as the additive element;
2 massppm to 12 massppm of sulfur; and
higher than 2 massppm and not more than 30 massppm of oxygen.

11. A soft dilute copper alloy stranded wire, comprising
a plurality of the soft dilute copper alloy wires according to claim 1 stranded together.
